(19) United States
(12) Patent Application Publication
(10) Pub. No.: US 2008/0179075 A1
(43) Pub. Date: Jul. 31, 2008

(54) Flat raw cable transmitting signal and power

(75) Inventor: Pei Tsao, La Habra, CA (US)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/699,278

(22) Filed: Jan. 29, 2007

(51) Int. Cl. H01B 7/08; H01B 7/00

(52) U.S. Cl. 174/115

(57) ABSTRACT

A flat raw cable (1) transmitting signal and power comprises a pair of signal transmitting conductors (10), two insulating layer (15) each enclosing corresponding signal conductor, a braided tinned copper shield (13) encloses the signal transmitting conductor pair and the insulating layer applied around the pair, a pair of power transmitting conductors (12) located out of the copper shield sandwich in between the signal transmitting conductors, and an insulating jack (16) enclosing the power and signal transmitting conductors.

### BACKGROUND OF THE INVENTION

1. Field of the Invention

The present invention relates to a flat raw cable, and particularly to a flat raw cable transmitting the signal as well as power.

2. Description of Prior Arts

As development, the consumer electronic becomes more and more smaller for attracting more consumers. As an accessory of the consumer electronic, the cables used for transmitting the signal and power, accordingly, should decrease the size. Micro-USB (Universal Serial Bus) connector is a common connector used on the portable consumer electronic, such as MP3 player, Digital camera, etc, for providing the power and signal. Usually, A flat raw cable and another cable mating with the Micro-USB connector for, respectively, transmitting the power and the signal. However, cause of the requirement of the miniaturization, the size of the cables transmitting power and signal should be further decreased.

### SUMMARY OF THE INVENTION

An object of the present invention is to provide a flat raw cable has a less size.

To achieve the above object, a flat raw cable transmitting signal and power, comprises a pair of signal transmitting conductors, two insulating layer each enclosing corresponding signal conductor, a braided tinned copper shield encloses the signal transmitting conductor pair and the insulating layer applied around the pair, a pair of power transmitting conductors located out of the copper shield sandwich in between the signal transmitting conductors, and an insulating jack enclosing the power and signal transmitting conductors.

Other objects, advantages and novel features of the invention will become more apparent from the following detailed description of the present embodiment when taken in conjunction with the accompanying drawings.

### BRIEF DESCRIPTION OF THE DRAWING

FIG. 1 is a cross-section view of the cable of in accordance with the present invention.

### DETAILED DESCRIPTION OF THE PREFERRED EMBODIMENT

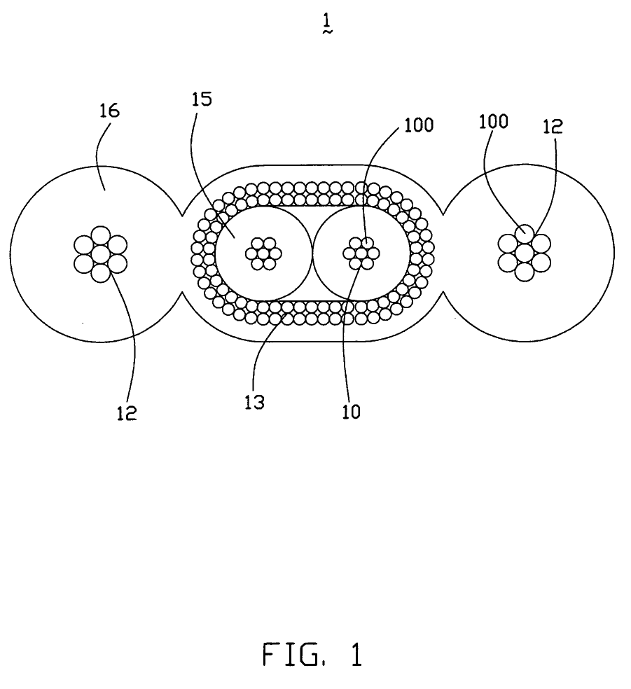

Referring to FIG. 1, a flat raw cable 1 in accordance with the present invention comprises a pair of signals transmitting conductors 10, a pair of power transmitting conductors 12 sandwich in between the signal transmitting conductors 10 pair, and a braided tinned copper shield 13. Each signal transmitting conductor 10 comprises a plurality of copper wires 100 spinning with each other, and an insulating layer 15 encloses the signal transmitting conductor 10. The braided tinned copper shield 13 encloses the signal transmitting conductor 10 pair applied around the pair. Each power transmitting conductor 12 comprises a plurality of copper wires 100 spinning with each other. The power transmitting conductors 12 pair are separated with the braided shield 13 and accord with UL (Underwriters Laboratories) style for Flexible Cords and Cables. An insulating jack 16 encloses both the power transmitting conductors and the signal transmitting conductors. The insulating layer 15 and jack 16 are made of HDPE (high-density polyethylene) in this embodiment.

The flat raw cable 1 can transmit the signal as well as power. And comparing to the two cables, respectively, transmitting power and signal, the flat raw just has one insulating jack for enclosing the conductors. Accordingly, the size of the flat raw cable transmitting both signal and power is decreased.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

I claim:

1. A flat raw cable transmitting signal and power, comprising:
a pair of signal transmitting conductors;
two insulating layer, each enclosing the signal conductor;
a braided tinned copper shield encloses the signal transmitting conductor pair and the insulating layer applied around the pair;
a pair of power transmitting conductors located out of and being separated with the copper shield, and sandwiching in between the signal transmitting conductors; and
an insulating jack enclosing the power and signal transmitting conductors.

2. The flat raw cable as described in claim 1, wherein the insulating layer and the insulating jack are both made of HDPE (high-density polyethylene).

3. The flat raw cable as described in claim 2, wherein each signal transmitting conductor comprises a plurality of copper wires spinning with each other.

4. The flat raw cable as described in claim 3, wherein each power transmitting conductor comprises a plurality of copper wires spinning with each other.

5. The flat raw cable as described in claim 4, wherein the power transmitting conductors pair accord with the UL (Underwriters Laboratories) style for Flexible Cords and Cables.

6. A flat raw cable transmitting signal and power, comprising:
a pair of signal transmitting conductors spaced from each other, each including
a plurality of wires;
said pair of signal transmitting conductors being closed within at least one insulating layer;
a braided tinned copper shield encloses the signal transmitting conductors and the insulating layer applied around the pair;
a pair of power transmitting conductors located out of and being separated with the copper shield, and by two sides of the signal transmitting conductors; and
an insulating jack enclosing the power and signal transmitting conductors; wherein
the braided tinned copper shield is of a capsule form, and the insulating jacket essentially complies with said capsule form except at two opposite ends thereof.

7. The flat raw cable as claimed in claim 8, wherein there are two of said at least one insulating layer respectively enclosing the corresponding signal transmitting conductors, and each said insulating layer is of a round configuration side by side abutting against each other and abutting against the braided tinned copper shield at two longitudinal ends of said braided tinned copper shield under a condition that a pair of triangle like recesses formed between the braided tinned copper shield around an abutment region between the two insulating layers.
